(19) United States
(12) Patent Application Publication
(10) Pub. No.: US 2011/0017957 A1
(43) Pub. Date: Jan. 27, 2011

(54) METHOD OF MANUFACTURING CONDUCTIVE COMPOSITE FIBRES WITH A HIGH PROPORTION OF NANOTUBES

(75) Inventors: Patrice Gaillard, Hagetaubin (FR); Philippe Poulin, Talence (FR); Célia Mercader, Saint-Michel-Sur-Orge (FR); Maryse Maugey, Gradignan (FR); Sandy Moisan, Pessac (FR); Alain Derre, Balizac (FR); Cécile Zakri, Le Barp (FR)

Correspondence Address: MILLEN, WHITE, ZELANO & BRANIGAN, P.C., 2200 CLARENDON BLVD., SUITE 1400, ARLINGTON, VA, 22201, US

(73) Assignees: ARKEMA FRANCE, Colombes (FR); CENTRE NATIONAL DE LA RECHERCHE SCIENTIFIQUE - CNRS, Paris (FR)

(21) Appl. No.: 12/787,917

(22) Filed: May 26, 2010

(30) Foreign Application Priority Data
May 27, 2009 (FR) 0953508

(51) Int. Cl. H01B 1/24; B29B 9/12

(52) U.S. Cl. 252/511; 264/13; 977/742; 977/750; 977/752; 977/842; 977/932

(57) ABSTRACT

This invention relates to a method of obtaining vinyl alcohol homo- or copolymer-based conductive composite fibres with a high proportion of nanotubes, particularly carbon nanotubes, which are capable of ensuring thermal and/or electric conduction. It likewise relates to the conductive composite fibres obtainable by this method as well as the uses thereof.

This invention relates to a method of obtaining vinyl alcohol homo- or copolymer-based conductive composite fibres with a high proportion of nanotubes, particularly carbon nanotubes, which are capable of ensuring thermal and/or electric conduction. It likewise relates to the conductive composite fibres obtainable by this method as well as the uses thereof.

Carbon nanotubes (or CNTs) are known and have specific crystalline structures of tubular shape, which are closed and hollow, which consist of atoms evenly arranged in pentagons, hexagons and/or heptagons and which are obtained from carbon. CNTs generally consist of one or more coaxially rolled graphite sheets. Thus, a distinction is made between single-walled nanotubes (SWNTs) and multi-walled nanotubes (MWNTs).

CNTs possess numerous high-performance properties, namely electrical, thermal, chemical and mechanical. Among the applications thereof, reference may be made, in particular, to composite materials intended in particular for the automobile, marine and aeronautical industries, electro-mechanical actuators, cables, resisting wires, chemical detectors, the storage and conversion of energy, electron emitter displays, electronic components and functional textiles. In the automobile, aeronautical and electronic fields, conductive fillers such as CNTs enable thermal and electrical dissipation of heat, and electric charges appear when friction occurs.

Generally speaking, when synthesized, CNTs are in the form of a disintegrated powder consisting of entangled filaments, thereby making same difficult to use with a view to exploiting the properties thereof. In particular, it is necessary for the CNTs to be present in large quantities and oriented in a preferential direction in order to exploit the mechanical and/or electrical properties thereof at the macroscopic level.

The most conventional way to incorporate CNTs into polymer fibres consists in mixing one or more thermoplastic polymers in molten form together with nanotubes. The mixture is then extruded in order to form one fibre or several fibres. This method, for example, is described in the international patent application WO 00/69958. Unfortunately, this approach does not enable production of fibres with a high proportion of nanotubes, because the mixture of the nanotubes in a molten polymer has very high viscosity levels as soon as the nanotube fraction increases.

Mother approach was proposed in French Patent Application FR 2 805 179 for producing fibres via coagulation of CNTs. This method consists in injecting a dispersion of nanotubes into the co-flow of a coagulating polymer solution. This method enables production of composite fibres with mass concentrations of carbon nanotubes greater than 10%. These fibres have good electrical and mechanical properties. Polyvinyl alcohol (PVA) is a particularly effective coagulant. The latter is adsorbed at the interface of the nanotubes and causes the nanotubes to adhere to one another in order to form a fibre. However, this method is slow and ill-suited at the industrial scale. A continuous process based on the same technique was described in French Patent Application FR 2 921 075. Its major disadvantage lies in the necessity of using complex equipment.

Another approach for producing CNT-filled polymer fibres consists in mixing the nanotubes and a polymer into a single solution prior to extrusion. The solution thus produced is next injected into a static bath or flow which causes the polymer to coagulate. The nanotubes mixed with the polymer are trapped inside the structure and the final object is a composite fibre filled with carbon nanotubes. The advantage of this principle is that it is based on the coagulation of the polymer and not directly on the coagulation of the nanotubes. The coagulation of the polymer enables quicker obtainment of consolidated fibres which can be easily handled and extracted from the coagulation baths, for example, in order to be washed, dried, drawn and wound. The extrusion of polymer fibres by coagulation in a solvent and the processing of same are well-described in literature.

This approach was thus adopted by Zhang et al (Gel Spinning of PVA/SWNT Composite Fibre, Polymer 45 (2004) 8801-8807) in order to produce nanotube-filled polyvinyl alcohol fibres. This publication describes the manufacture of composite fibres according to a method in which the PVA and the CNTs are placed in solution in a mixture of water and dimethyl sulphoxide (DMSO). This dispersion is injected into a coagulation solution consisting of methanol cooled to −25° C. It is difficult to form a high-concentration dispersion of nanotubes without causing the formation of aggregates in a PVA solution, because the PVA itself causes coagulation of the nanotubes. The presence of aggregates causes the formation of inhomogeneities in the fibre, which are detrimental to the physical properties and textural uniformity thereof. For this reason, the fibres described by Zhang et al contain a maximum mass concentration of carbon nanotubes of 3%.

In another publication, Xue et al (Electrically Conductive Yarns Based on PVA/Carbon Nanotubes, Composite Structures 78 (2007) 271-277) produced PVA/CNT composite fibres with CNT to PVA ratios has high as 40% by weight. In this method, the CNTs are dispersed in an aqueous PVA solution. However, they observed that, at such concentrations, the fibre obtained was not uniform, which was attributed to a non-homogenous dispersion of the nanotubes and to the formation of aggregates.

The Applicant anticipated adapting the above method by subjecting the CNTs to an oxidizing treatment, so as to create polar groups at the surface thereof. However, this solution does not enable the coagulation of the CNTs in the presence of PVA to be prevented. The use of sodium lauryl sulphate type ionic surfactants also does not enable this coagulation to be prevented. It was also anticipated to include poly (acrylic acid) in order to remedy this problem. However, it was observed that the latter inhibited the eventual coagulation of the PVA and thus the formation of the fibre.

There remains the need, therefore, to propose a simple method enabling preparation of homogeneous conductive composite fibres with a high proportion of nanotubes, i.e., containing at least 5% by weight of nanotubes. In addition, the need also remains to manufacture fibres having a mechanical failure threshold greater than 100 MPa.

The Applicant discovered that these needs could be met by implementing a method of manufacturing conductive composite fibres in which nanotubes placed in dispersion in a vinyl alcohol homo- or copolymer solution are stabilised by means of stabilising agents.

Thus, the object of this invention is a method of manufacturing a conductive composite fibre comprising the successive steps consisting of:

a) the formation of a dispersion of nanotubes capable of ensuring thermal and/or electrical conduction, consisting in at least one chemical element chosen from amongst the elements of columns IIIa, IVa and Va of the periodic table, in a vinyl alcohol homo- or copolymer solution, in the presence of at least one stabilising agent covalently or non-covalently bonded to the nanotubes,

b) the injection of said dispersion into a coagulating solution in order to form a pre-fibre,

c) the extraction of said pre-fibre,

d) the optional washing of said pre-fibre,

e) the drying of said pre-fibre in order to obtain a fibre containing from 5 to 70% by weight of nanotubes relative to the total weight of the fibre.

It is clearly understood that the method according to the invention may possibly include other preliminary, intermediate and/or subsequent steps from those mentioned above, insofar as they do not negatively affect the formation of the conductive composite fibre.

As an introductory statement, it is specified that, throughout this description, the expression “between” should be interpreted as including the stated limits. Within the meaning of this invention, the term “fibre” is understood to mean a strand the diameter of which is between 100 nm (nanometres) and 300 μm (micrometres), better yet, between 2 and 50 μm (micrometres). Additionally, this structure may or may not be porous. As concerns its uses, a fibre is intended to ensure the strength of a mechanical part and does not constitute a tube or pipeline intended for the transport of a fluid.

According to the invention, the nanotubes consist of at least one chemical element chosen from amongst the elements of columns IIIa, Iva and Va of the periodic table. The nanotubes must be capable of ensuring thermal and/or electrical conduction; they may thus contain boron, carbon, nitrogen, phosphorous or silicon. For example, they may consist of or contain carbon, carbon nitride, boron nitride, boron carbide, boron phosphide, phosphorous nitride or carbon boronitride, or else silicon.

Carbon nanotubes (or “CNTs”) are preferably used. These are hollow, graphitic carbon fibrils, each comprising one or more graphitic tubular walls oriented along the axis of the fibril. The nanotubes normally have an average diameter ranging from 0.1 to 100 nm (nanometres), more preferably from 0.4 to 50 nm (nanometres) and, better yet, from 1 to 30 nm (nanometres), and advantageously a length of 0.1 to 10 μm (micrometres). The length/diameter ratio thereof is preferably greater than 10 and most often greater than 100 or even greater than 1000. The specific surface area thereof, for example, is between 100 and 500 m²/g (limits included), generally between 100 and 300 in²/g for multi-walled nanotubes, and may even reach up to 1300 m²/g in the case of single-walled nanotubes. The apparent density thereof may, in particular, be between 0.05 and 0.5 g/cm³ (limits included).

The multi-walled nanotubes, for example, may include from 5 to 15 sheets (or walls) and more preferably from 7 to 10 sheets. These nanotubes may be processed or unprocessed.

Carbon nanotubes are commercially available or can be prepared by known methods. An example of unprocessed carbon nanotubes is, in particular, commercially available from the ARKEMA France Company, under the trade name of Graphistrength® C100.

Several methods exist for synthesizing carbon nanotubes, in particular electric discharge, laser ablation, and chemical vapour deposition (CVD), which enables large-scale manufacture of carbon nanotubes and therefore the obtainment thereof at a cost price compatible with the mass use of same. This method consists precisely in injecting a carbon source at a relatively high temperature onto a catalyst, which can itself consist of a metal such as iron, cobalt, nickel or molybdenum, supported on an inorganic solid such as alumina, silica or magnesia. The carbon sources can include methane, ethane, ethylene, acetylene, ethanol, bio-ethanol, methanol or even a mixture of carbon monoxide and hydrogen (HiPCO method).

Thus, the application WO 86/03455A1 by Hyperion Catalysis International, Inc. describes, in particular, the synthesis of carbon nanotubes. More particularly, the method includes placing a particle containing a metal such as iron, cobalt or nickel, in particular, in contact with a gaseous carbon-based compound, at a temperature of between 850° C. and 1200° C., the dry weight proportion of the carbon-based compound relative to the metal-based particle being at least approximately 100:1.

As desired, and optionally in combination, these nanotubes can be purified, processed (e.g., oxidised) and/or ground prior to the implementation of same in the method according to the invention.

Grinding of the nanotubes can in particular be carried out when cold or hot and can be carried out according to known techniques used in devices such as ball mills, hammer mills, edge-runner mills, knife mills, gas jet mills or any other grinding system capable of reducing the size of the entangled network of nanotubes. It is preferred that the grinding step be carried out according to a gas-jet grinding technique and, in particular, in an air-jet mill, or in ball mill.

Purification of the raw or ground nanotubes can be carried out by washing with a sulphuric acid solution so as to rid them of possible residual mineral or metallic impurities resulting from the method of preparation thereof. The weight ratio of nanotubes to sulphuric acid can in particular be between 1:2 and 1:3 (limits included). In addition, the purification operation can be carried out at a temperature ranging from 90 to 120° C., e.g., for a time period of 5 to 10 hours. This operation can advantageously be followed by steps of rinsing with water and of drying the purified nanotubes. The purification can also consist of a high-temperature heat treatment, typically greater than 1000° C.

Oxidation of the nanotubes is advantageously carried out by placing same in contact with a sodium hypochlorite solution containing from 0.5 to 15% by weight of NaOCl, and preferably from 1 to 10% by weight of NaOCl, e.g., in a weight ratio of nanotubes to sodium chlorite ranging from 1:0.1 to 1:1. The oxidation is advantageously carried out at a temperature lower than 60° C. and preferably at ambient temperature, for a time period ranging from a few minutes to 24 hours. This oxidation operation can advantageously be followed by steps of filtering and/or centrifuging, washing and drying the oxidised nanotubes.

In order to eliminate the metallic catalyst residues, it is likewise possible to subject the nanotubes to a heat treatment of at least 1000° C., e.g., 1200° C.

The first step of the method according to the invention consists in forming a dispersion of nanotubes in a vinyl alcohol homo- or copolymer solution, in the presence of at least one stabilising agent covalently or non-covalently bonded to the nanotubes. The vinyl alcohol homo- or copolymer is advantageously the polyvinyl alcohol) itself.

Depending on the nature of the solution made and the nature of the polymer, the molecular mass thereof can be between 5,000 and 300,000 g/mol. The degree of hydrolysis of same can be greater than 96%, or even greater than 99%.

Within the meaning of this invention, a “stabilising agent” is understood to mean a compound enabling homogeneous dispersion of the nanotubes in the solution, which protects the nanotubes from coagulation in the presence of the vinyl alcohol homo- or copolymer, but which does not impede the coagulation of the vinyl alcohol homo- or copolymer in a coagulating solution.

The stabilising agent or agents according to the invention are bonded to the nanotubes either covalently or non-covalently.

In the case where the stabilising agent is bonded to the nanotubes non-covalently, it may be chosen from amongst the substantially non-ionic surfactants.

Within the meaning of this invention, a “substantially non-ionic surfactant” is understood to mean a non-ionic amphiphilic compound, cited, for example, in the work 2008 McCutcheon's “Emulsifiers and Detergents,” and preferably having an HLB (hydrophilic-lipophilic balance) of 13 to 16, as well as block copolymers containing hydrophilic blocks and lipophilic blocks and having low ionicity, e.g., 0% to 10% by weight of ionic monomer and 90% to 100% of non-ionic monomer.

For example, within the scope of this invention, the stabilising agent or agents bonded to the nanotubes non-covalently can be chosen from amongst:

(i) the polyol esters, in particular:
fatty acid and sorbitan esters, optionally poly-ethoxylated, e.g., surfactants of the Tween® family,
fatty acid and glycerol esters,
fatty acid and sucrose esters,
fatty acid and polyethylene glycol esters,

(ii) polyether-modified polysiloxanes,

(iii) fatty alcohol and polyethylene glycol ethers, e.g., surfactants of the Brij® family,

(iv) alkyl polyglycosides,

(v) polyethylene-polyethylene glycol block copolymers.

In the second case where the stabilising agent is bonded to the nanotubes covalently, this preferably involves a hydrophilic group, and advantageously a polyethylene glycol group grafted onto the nanotubes.

Grafting of the reactive units such as polyethylene glycol groups to the surface of the nanotubes can be carried out according to any method known to a person skilled in the art. For example, a person skilled in the art will be able to refer to the publication by B. Zhao et al (Synthesis and Characterization of Water Soluble Single-Walled Carbon Nanotube Graft Copolymers, J. Am. Chem. Soc. (2005) Vol. 127 No. 22). According to this publication, the nanotubes are dispersed in dimethylformamide (DMF) and are placed in contact with oxalyl chloride. In a second stage, the resulting dispersion is placed in contact with polyethylene glycol (PEG). The nanotubes thus grafted are purified.

Furthermore, the dispersion produced in the first step of the method according to the invention includes a solvent which is preferably chosen from amongst water, dimethyl sulphoxide (DMSO), glycerine, ethylene glycol, diethylene glycol, triethylene glycol, diethylenetriamine, ethylenediamine, phenol, dimethylformamide (DMF), dimethylacetamide, N-methylpyrrolidone and the mixtures thereof. The solvent is preferably chosen from amongst water, DMSO and the mixtures thereof in all proportions.

If it is an aqueous dispersion, the pH of the aqueous dispersion can be kept preferably between 3 and 5 by adding one or more acids choosable from amongst inorganic acids, such as sulphuric acid, nitric acid and hydrochloric acid, organic acids such as acetic acid, tartaric acid and oxalic acid, and the mixtures of an organic acid and an organic acid salt such as citric acid and sodium citrate, acetic acid and sodium acetate, tartaric acid and potassium tartrate, tartaric acid and sodium citrate.

Furthermore, the dispersion can include boric acid, borate salts or the mixtures thereof.

In addition, the dispersion can also include a salt chosen from amongst zinc chloride, sodium thiocyanate, calcium chloride, aluminium chloride, lithium chloride, rhodanates and the mixtures thereof. They enable the rheologic properties of the dispersion to be optimised and to promote the formation of the fibre.

According to one advantageous form of this invention, the dispersion is produced by means of ultrasound or a rotor-stator system or a ball mill. It can be produced at ambient temperature, or else by heating, for example, to between 40 and 120° C.

The dispersion thus produced during the first step of the method according to the invention can include from 2% to 30% by weight of vinyl alcohol homo- or copolymers, from 0.1% to 5% of nanotubes, from 0.1% to 5% of a stabilising agent, in relation to the total weight of the dispersion, solvent included.

The second step of the method consists in injecting said dispersion obtained during the first step into a coagulating solution, in order to form a pre-fibre in the form of a monofilament or multifilaments.

Within the meaning of this invention, a “coagulating solution” is understood to mean a solution which causes the solidification of the vinyl alcohol homo- or copolymer.

Such solutions are known to a person skilled in the art, and the production of vinyl alcohol homo- or copolymer-based fibres is the subject of an extensive body of literature. Generally speaking, the most common techniques are wet-spinning of PVA (refer, for example, to the U.S. Pat. No. 3,850,901, U.S. Pat. No. 3,852,402 and U.S. Pat. No. 4,612,157), and dry jet wet-spinning of PVA (refer, for example, to the U.S. Pat. No. 4,603,083, U.S. Pat. No. 4,698,194, U.S. Pat. No. 4,971,861, U.S. Pat. No. 5,208,104 and U.S. Pat. No. 7,026,049).

According to one advantageous embodiment of the invention, the coagulating solution includes a solvent chosen from amongst water, an alcohol, a polyol, a ketone and the mixtures thereof, more preferably a solvent chosen from amongst water, methanol, ethanol, butanol, propanol, isopropanol, a glycol, acetone, methyl ethyl ketone, methyl isobutyl ketone, benzene, toluene and the mixtures thereof, and even more preferably a solvent chosen from amongst water, methanol, ethanol, a glycol, acetone and the mixtures thereof.

If the solvent of the coagulating solution is substantially water, the coagulating solution advantageously has a temperature of between 10 and 80° C. If the solvent of the coagulating solution is substantially organic, such as methanol, the coagulating solution advantageously has a temperature of between −30 and 10° C.

In addition, the coagulating solution can include one or more salts intended to promote the coagulation of the vinyl alcohol homo- or copolymer, chosen from amongst alkaline salts or dehydrating salts such as ammonium sulphate, potassium sulphate, sodium sulphate, sodium carbonate, sodium hydroxide, potassium hydroxide and the mixtures thereof.

In addition, the coagulating solution can include one or more additional compounds which are intended to improve the mechanical properties, the water resistance of the fibre and/or to promote extrusion of the fibre. The coagulating solution can therefore include at least one compound chosen from amongst boric acid, borate salts and the mixtures thereof.

The coagulating solution is preferably salt-saturated.

The dispersion is advantageously injected; during the second step of the method according to the invention, through one or a set of needles and/or one or a set of non-porous cylindrical or conical nozzles, into the coagulating solution, which may be static (static bath) or in motion (flow). The average rate of injection of the dispersion can be between 0.1 m/min and 50 m/min, preferably between 0.5 m/min and 20 m/min.

The coagulating solution causes the vinyl alcohol homo- or copolymer to coagulate by solidification in the form of a pre-fibre. The nanotubes are trapped in the polymer which solidifies.

The next step of the method according to the invention consists in continuously or non-continuously extracting the pre-fibre from the coagulating solution.

After the pre-fibre has been extracted, it may be optionally washed one or more times. The wash tank preferably contains water. The washing step can enable a portion of the peripheral polymer of the fibre to be eliminated and to thereby enrich (by up to 70% by weight) the nanotube composition of the pre-fibre. Furthermore, the washing bath can include agents which enable the composition of the pre-fibre to be modified or which interact chemically therewith. In particular, chemical or physical crosslinking agents, in particular borate salts or dialdehydes, can be added to the bath so as to strengthen the pre-fibre. The washing step can also enable the agents to be eliminated, in particular the surfactants, which are potentially harmful to the mechanical or electrical properties of the fibre.

A drying step is likewise included in the method according to the invention. This step can take place either immediately after the extraction operation, or consecutively with the washing operation. In particular, if one wishes to obtain a polymer-enriched fibre, it is desirable to dry the pre-fibre immediately after extraction. The drying operation is preferably carried out in an oven which will dry the pre-fibre owing to a gas circulating inside an interior duct of the oven. The drying operation can also be carried out via infrared radiation.

The method according to the invention can likewise include a winding step, and possibly a hot-drawing step carried out between the drying step and the winding step. At various times, it can also include stretching operations in solvents.

This drawing step can be carried out at a temperature higher than the glass transition temperature (Tg) of the vinyl alcohol homo- or copolymer, and preferably lower than the melting temperature of same (if it exists). Such a step, which is described in the U.S. Pat. No. 6,331,265, enables the nanotubes and the polymer to be oriented in substantially the same direction, along the axis of the fibre, and to thereby improve the mechanical properties thereof, in particular the Young's modulus and failure threshold of same. The draw ratio, defined as the ratio of the length of the fibre after drawing to the length of same prior to drawing, can be between 1 and 20, preferably between 1 and 10, limits included. The drawing operation can be performed once, or several times, while allowing the fibre to relax slightly between each drawing operation. This drawing step is preferably carried out by passing the fibres through a series of rollers having different rotational speeds, those which unwind the fibre rotating at a slower speed than those which receive it. In order to reach the desired drawing temperature, either the fibres can be passed through ovens arranged between the rollers, or heating rollers can be used, or these two techniques can be combined. This drawing step enables the fibre to be consolidated and high stress levels to be attained at the failure threshold.

The object of this invention are the conductive composite fibres obtainable according to the method of the invention.

Said resulting conductive composite fibres are characterised in that they contain from 5 to 70% by weight of nanotubes, preferably from 5 to 50%, more preferably from 5 to 30%, and better yet from 5 to 25%, relative to the total weight of the fibres. It is therefore possible to obtain composite fibres with a high proportion of nanotubes.

The resulting fibre is homogeneous, which gives it good mechanical properties. The fibre can be characterised mechanically by a traction test, and it has:
a mechanical failure threshold (or tenacity) preferably greater than 100 MPa, more preferably greater than 300 MPa, and better yet greater than 500 MPa;
an elongation at break preferably between 0.1 and 500% elongation, more preferably between 1 and 400% elongation, and better yet between 3 and 400% elongation; and
a Young's modulus (or traction modulus) preferably between 1 and 100 GPa, preferably between 2 and 60 GPa.

Furthermore, the conductive composite fibres obtained according to this method have a resistivity which can be between 10⁻³ and 10⁵ ohm-cm at ambient temperature. This electrical conductivity can be further improved by heat treatments.

Another object of this invention are conductive composite fibres including:
from 5 to 70% by weight, relative to the total weight of the fibres, of nanotubes capable of ensuring thermal and/or electric conduction and consisting of at least one chemical element chosen from amongst the elements of columns IIIa, IVa and Va of the periodic table,
a vinyl alcohol homo- or copolymer, and
at least one stabilising agent, bonded to the nanotubes non-covalent y, which is chosen from amongst substantially non-ionic surfactants having an HLB of 13 to 16.

Finally, an object of this invention is the use of the conductive composite fibres according to the invention for the following applications:
for the manufacture of noses, wings or cockpits of rockets or aircraft;
for the manufacture of offshore hose armouring;
for the manufacture of automobile body, engine chassis parts or carriage pieces for automobiles;
for the manufacture of automobile seat covers;
for the manufacture of structural members in the field of construction or bridges and roadways;
for the manufacture of packages and antistatic textiles, in particular antistatic curtains, antistatic clothing (e.g., for safety or for clean rooms) or materials for the protection of silos or the packaging and/or transport of powders or granular materials;
for the manufacture of furnishing elements, in particular for clean room furniture;
for the manufacture of filters;
for the manufacture of electromagnetic armour devices, in particular for the protection of electronic components;
for the manufacture of heating textiles;
for the manufacture of conducting cables;
for the manufacture of sensors, in particular deformation or mechanical stress sensors;
for the manufacture of electrodes;
for the manufacture of hydrogen storage devices; or biomedical devices such as suture threads, prostheses or catheters.

The manufacture of these composite parts can be carried out according to various methods, generally involving a step of impregnating the conductive composite fibres according to the invention with a polymeric composition containing at least one thermoplastic, elastomeric or thermosetting material. This impregnating step can itself be carried out according to various techniques, based in particular on the physical form of the polymeric composition used (powdery or more or less liquid). The impregnation of the conductive composite fibres is preferably carried out according to a fluidised-bed impregnation method in which the polymeric composition is in the powdered state. Pre-impregnated fibres are thus obtained.

Semi-finished products are thus obtained, which are next used in the manufacture of the desired composite part. Various pre-impregnated fibre fabrics of identical or different composition can be stacked in order to form a plate or laminated material, or alternatively subjected to a heat-forming process. Alternatively, the pre-impregnated fibres can be combined in order to form strips which are capable of being used in a filament winding process enabling obtainment of hollow parts of almost unlimited shape, by winding strips around a mandrel having the shape of the part being manufactured. In every case, the manufacture of the finished part includes a step of consolidating the polymeric composition, which, for example, is melted locally in order to create regions where the pre-impregnated fibres attach to one another and/or in order to join the strips of pre-impregnated fibres in the filament winding process.

In another alternative, it is possible to prepare a film from the impregnating polymeric composition, in particular by means of an extrusion or calendering method, said film, for example, having a thickness of approximately 100 μm, and to then place same between two mats of conductive composite fibres according to the invention, the entire assembly then being hot-pressed in order to enable impregnation of the fibres and the manufacture of the composite part.

In these methods, the conductive composite fibres according to the invention can be woven or knitted alone or with other fibres, or be used alone or in combination with other fibres, for the manufacture of felts or non-woven materials. Examples of materials consisting of these other fibres include, without limitation
drawn polymer fibres containing, in particular: polyamide such as polyamide 6 (PA-6), polyamide 11 (PA-11), polyamide 12 (PA-12), polyamide 6.6 (PA-6.6), polyamide 4.6 (PA-4.6), polyamide 6.10 (PA-6.10) or polyamide 6.12 (PA-6.12), polyamide/polyether block copolymer (Pebax®), high-density polyethylene, polypropylene or polyester such as polyhydroxyalkanoates and polyesters marketed by DuPont under the trade name of Hytrel®,
carbon fibres;
glass fibres, in particular of type B, R or S2;
aramide fibres (Kevlar®);
boron fibres;
silica fibres;
natural fibres such as flax, hemp, sisal, cotton or wool; and
the mixtures thereof, such as mixtures of glass, carbon and aramide fibres.

Thus, another object of this invention are the composite materials including conductive composite fibres according to the invention, bound together by weaving or by a polymeric composition.

Other characteristics and advantages of the invention will become apparent upon reading the following non-limiting and purely illustrative examples.

### BRIEF DESCRIPTION OF THE DRAWINGS

FIG. 1 is a scanning microscope slide showing a fiber prepared by Example 1.

### EXAMPLES

### Example 1

0.5% by weight of single-walled carbon nanotubes and 1% Brij®78 were dispersed in water. This dispersion was then homogenised with an ultrasound probe operated at 20 W of power.

8% by weight of an aqueous poly(vinyl alcohol) (PVA) solution with a molecular weight of 195,000 g/mol and a degree of hydrolysis of 98% was added. The resulting dispersion, consisting of 0.25% by weight of single-walled nanotubes, 0.5% Brij®78 and 4% PVA in water, was homogenised by magnetic stirring.

The dispersion was then injected into a static bath of a saturated sodium sulphate coagulating solution (320 g/L) at 40° C.

The pre-fibre was extracted from the coagulating bath after a residence time of less than ten seconds. It was next dried by infrared radiation, then redirected into a washing bath containing water. After 1 min, it was dried again by infrared radiation and then wound.

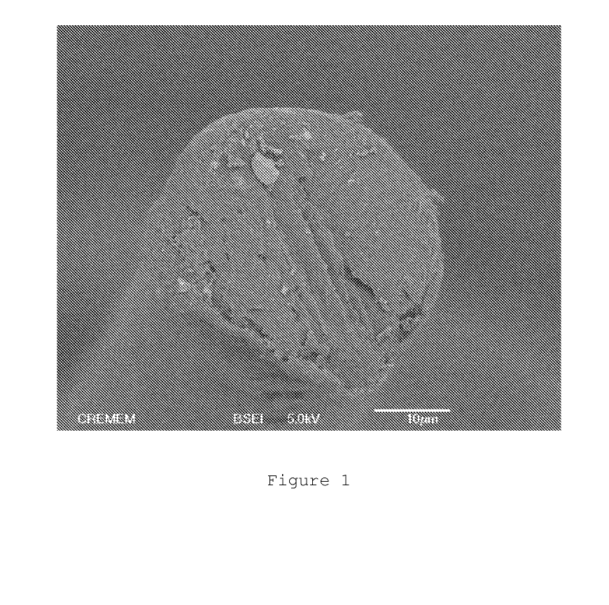

The final fibre obtained contains 8% by weight of nanotubes. This value was obtained by thermogravimetric analysis (TGA). The scanning microscopy slide introduced in FIG. 1 shows a circular fibre of 40 μm in diameter.

The fibre is cylindrical and homogenous and was characterised mechanically by traction. It has an energy-to-break of 475 J/g, an elongation at break of 425% elongation and a Young's modulus of 3 GPa. After hot-stretching to 400% at 200° C., its Young's modulus increases up to 29 GPa and its failure threshold passes to 12% elongation.

### Example 2

Composite fibres were produced starting from aqueous dispersions of multi-walled nanotubes. 0.9% by weight of nanotubes and 1.2% Brij®78 were dispersed in water. Using the same method as described in Example 1, fibres filled with 17% multi-walled nanotubes were obtained.

These fibres have the advantage of combining good mechanical properties with entirely beneficial electrical properties, since they conduct electricity, with a resistivity of 10 Ω-cm. They have a tenacity of 340 MPa, a Young's modulus of 5.5 GPa and an elongation at break of 240%.

### Example 3

0.9% by weight of multi-walled carbon nanotubes and 1.2% of Brij®78 were dispersed in water. The mixture was next homogenised with an ultrasound probe operated at 20 W of power.

16% by weight of an aqueous polyvinyl alcohol) (PVA) solution with a molecular weight of 61,000 g/mol and a degree of hydrolysis of 98% was next added to this dispersion. The resulting dispersion as homogenised by magnetic stirring. Boric acid in the amount of 0.5% by weight in relation to the PVA was added to this dispersion, and the pH was brought to a value lower than 5 by adding diluted nitric acid. A dispersion was thus obtained, consisting of 0.45% by weight of single-walled nanotubes, 0.6% Brij®78 and 8% PVA in water.

The solution was next injected into a static bath of a saturated sodium sulphate coagulating solution (320 g/L) at 40° C. in order to form a fibre. The final fibre obtained contains 12% by weight of nanotubes. It has a tenacity of 360 MPa, a Young's modulus of 4 GPa and an elongation at break of 325%, as well as a resistivity of 30 Ω-cm.

### Example 4

The dispersion described in Example 3 was injected into a coagulating bath containing sodium hydroxide (50 g/L) and sodium sulphate (300 g/L) at 40° C.

The final fibre obtained contains 12% by weight of nanotubes. It has a tenacity of 32 MPa, a Young's modulus of 7 GPa and an elongation at break of 200%, as well as a resistivity of 100 Ω-cm.

### Example 5

0.5% by weight of multi-walled carbon nanotubes and 1% Brij®78 were dispersed in a water/DMSO mixture comprising the same mass concentration for each solvent.

A 16% by weight PVA solution in a water/DMSO mixture with a molecular weight of 61,000 g/mol and a degree of hydrolysis of 98% was next added to this dispersion. The dispersion thus obtained, consisting of 0.25% by weight of multi-walled nanotubes, 0.5% Brij®78 and 8% PVA was homogenised by magnetic stirring.

The dispersion was then injected into a methanol coagulating bath at −20° C. containing 10% DMSO, in order to form fibres filled with 8% nanotubes.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding FR application No. 0953508, filed May 27, 2009, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Method of manufacturing a conductive composite fibre, comprising the successive steps consisting of:
a) the formation of a dispersion of nanotubes capable of ensuring thermal and/or electrical conduction, consisting in at least one chemical element chosen from amongst the elements of columns IIIa, IVa and Va of the periodic table, in a vinyl alcohol homo- or copolymer solution, in the presence of at least one stabilising agent covalently or non-covalently bonded to the nanotubes,
b) the injection of said dispersion into a coagulating solution in order to form a pre-fibre,
c) the extraction of said pre-fibre,
d) the optional washing of said pre-fibre,
e) the drying of said pre-fibre in order to obtain a fibre containing from 5 to 70% by weight of nanotubes relative to the total weight of the fibre.

2. Method of manufacturing a conductive composite fibre of claim 1, characterised in that the nanotubes are carbon nanotubes.

3. Method of manufacturing a conductive composite fibre as claimed in claim 1, characterised in that stabilising agents are bonded to the nanotubes non-covalently and are chosen from amongst the substantially non-ionic surfactants, such as
(i) the polyol esters, in particular:
fatty acid and sorbitan esters, optionally poly-ethoxylated,
fatty acid and glycerol esters,
fatty acid and sucrose esters,
fatty acid and polyethylene glycol esters,
(ii) polyether-modified polysiloxanes,
(iii) fatty alcohol and polyethylene glycol ethers,
(iv) alkyl polyglycosides,
(v) polyethylene-polyethylene glycol block copolymers.

4. Method of manufacturing a conductive composite fibre as claimed in claim 1, characterised in that stabilising agents are hydrophilic groups, advantageously polyethylene glycol groups grafted onto the nanotubes.

5. Method of manufacturing a conductive composite fibre as claimed in claim 1, characterised in that the vinyl alcohol homo- or copolymer is poly(vinyl alcohol).

6. Method of manufacturing a conductive composite fibre as claimed in claim 1, characterised in that the dispersion includes a solvent which is chosen from amongst water, dimethyl sulphoxide (DMSO), glycerine, ethylene glycol, diethylene glycol, triethylene glycol, diethylenetriamine, ethylenediamine, phenol, dimethylformamide (DMF), dimethylacetamide, N-methylpyrrolidone and the mixtures thereof, preferably a solvent chosen from amongst water, DMSO and the mixtures thereof in all proportions.

7. Method of manufacturing a conductive composite fibre as claimed in claim 1, characterised in that the dispersion further includes boric acid, borate salts or the mixtures thereof.

8. Method of manufacturing a conductive composite fibre as claimed in claim 1, characterised in that the dispersion is produced by means of ultrasound or a rotor-stator system or a ball mill.

9. Method of manufacturing a conductive composite fibre as claimed in claim 1, characterised in that the coagulating solution includes a solvent chosen from amongst water, an alcohol, a polyol, a ketone and the mixtures thereof, more preferably a solvent chosen from amongst water, methanol, ethanol, butanol, propanol, isopropanol, a glycol, acetone, methyl ethyl ketone, methyl isobutyl ketone, benzene, toluene and the mixtures thereof, and even more preferably a solvent chosen from amongst water, methanol, ethanol, a glycol, acetone and the mixtures thereof.

10. Method of manufacturing a conductive composite fibre as claimed in claim 1, characterised in that the coagulating solution includes at least one compound chosen from amongst ammonium sulphate, potassium sulphate, sodium sulphate, sodium carbonate, sodium hydroxide, potassium hydroxide, boric acid, borate salts and the mixtures thereof.

11. Conductive composite fibres obtainable according to the method as claimed in claim 1.

12. Conductive composite fibres of claim 11, characterised in that said fibres contain from 5 to 50%, preferably from 5 to 30%, and more preferably from 5 to 25% by weight of nanotubes relative to the total weight of the fibres.

13. Conductive composite fibres as claimed in claim 11, characterised in that said fibres have a mechanical failure threshold greater than 100 MPa, preferably greater than 300 MPa, and even more preferably greater than 500 MPa.

14. Conductive composite fibres as claimed in claim 11, characterised in that said fibres have an electric resistivity of between 10⁻³ and 10¹⁰ ohm-cm.

15. Conductive composite fibres including:
from 5 to 70% by weight, relative to the total weight of the fibres, of nanotubes capable of ensuring thermal and/or electric conduction and consisting of at least one chemical element chosen from amongst the elements of columns IIIa, IVa and Va of the periodic table,
a vinyl alcohol homo- or copolymer, and
at least one stabilising agent, bonded to the nanotubes non-covalently, which is chosen from amongst substantially non-ionic surfactants having an HLB of 13 to 16.

16. Use of the conductive composite fibres as claimed in claim 15 for the manufacture of noses, wings or cockpits of rockets or aircraft; offshore hose armouring; automobile body, engine chassis parts or carriage pieces for automobiles; automobile seat covers; structural members in the field of construction or bridges and roadways; packages and antistatic textiles, in particular antistatic curtains, antistatic clothing (e.g., for safety or for clean rooms) or materials for the protection of silos or the packaging and/or transport of powders or granular materials; furnishing elements, in particular for clean room furniture; filters; electromagnetic armour devices, in particular for the protection of electronic components; heating textiles; conducting cables; sensors, in particular deformation or mechanical stress sensors; electrodes; hydrogen storage devices; or biomedical devices such as suture threads, prostheses or catheters.

17. Composite material including conductive composite fibres as claimed in claim 15, bound together by weaving or by a polymeric composition.
